(19) United States
(12) Patent Application Publication
(10) Pub. No.: US 2010/0125379 A1
(43) Pub. Date: May 20, 2010

(54) Device Allowing Improvement in Maintenance Procedures for Onboard Equipment

(75) Inventors: François Fournier, Roques Sur Garonne (FR); Christian Sannino, Toulouse (FR); Carine Bailly, Tournefeuille (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/577,498

(22) Filed: Oct. 12, 2009

(30) Foreign Application Priority Data
Nov. 14, 2008 (FR) 08 06374

(51) Int. Cl. G06F 19/00

(52) U.S. Cl. 701/3

(57) ABSTRACT

The present invention relates to the field of aiding ground maintenance of an aircraft. More particularly, the invention consists of a portable access terminal intended to aid maintenance, commonly designated by the acronym PMAT for Portable Maintenance Access Terminal.

The invention exhibits the advantage of allowing the consideration of human factors in the design of maintenance strategies and procedures in the field of aeronautics. The implementation of portable access terminals according to the invention in the heart of a system for aiding maintenance is aimed at limiting the risks of human errors within the framework of aircraft maintenance operations and, optionally, the adaptation of the maintenance strategies and procedures to particular profiles of maintenance personnel.

### PRIORITY CLAIM

This application claims priority to French Patent Application Number 08 06374, entitled Device Allowing Improvement in Maintenance Procedures for Onboard Equipment, filed on Nov. 14, 2008.

### TECHNICAL FIELD

The present invention relates to the field of aiding ground maintenance of an aircraft. More particularly, the invention consists of a portable access terminal intended to aid maintenance, commonly designated by the acronym PMAT standing for “Portable Maintenance Access Terminal”, and intended to allow the consideration of human factors in the design of maintenance procedures in the aeronautical field.

### BACKGROUND OF THE INVENTION

Currently, the ground maintenance of an aircraft comprises various steps, beginning with the filling in by the onboard personnel of a logbook listing the set of alarms, anomalies, or other events observed by the crew during the flight. After the flight, the centralized maintenance system of the aeroplane, of the CFDIU type, standing for “Centralized Fault Display Interface Unit”, or CMC type, standing for “Centralized Maintenance Computer”, generally draws up a flight report, called a PFR, the acronym standing for Post Flight Report. Subsequently, the intervention of the maintenance personnel is based on the consideration of the logbook, of the PFR, and optionally of the general state of the aircraft, such as deduced from the status of the onboard sensors, which is accessible by way of reports of the ACMS type, standing for “Aircraft Condition & Monitoring System”.

The events noted in the logbook and the PFR may demand maintenance operations. After having consulted the document giving an inventory of the necessary and sufficient equipment with a view to performing a flight, a document designated by the term MEL, the acronym standing for “Minimum Equipment List”, the maintenance personnel may deduce the need or otherwise to perform maintenance operations in the immediate future.

If diagnostic actions have to be undertaken, the latter are summarized in a manual often called by the acronym FIM standing for “Fault Isolation Manual” or TSM standing for “Troubleshooting Manual”. Several levels of documents detailing the procedures and the various individual tasks to be undertaken are then at the disposal of the maintenance personnel. The various procedures are detailed in a second level of documentation designated by the term AMM, the acronym standing for “Aircraft Maintenance Manual”.

To summarize, in accordance with the current state of the art, today maintenance personnel consider the logbook of an aircraft on the ground. A portable access terminal intended to aid maintenance, or PMAT, is generally at the disposal of maintenance personnel. This PMAT can in a customary manner be connected to the aeroplane so as, for example, to retrieve the logbook in electronic form, as well as the PFR prepared by the maintenance system. Current aircraft being equipped with sensors the information from which is centralized at the level of computers by way notably of ACMS systems the PMAT can allow maintenance personnel to access all the necessary information. Said necessary information notably relates on the state of the aircraft and the status of the onboard sensors.

Theoretically, the maintenance personnel then perform the required maintenance operations, in accordance with the set of actions advised by the MEL and the FIM or the TSM, and by consulting the procedures in the AMM when requested to do so. In turn, they then fill in the logbook to indicate the operations that they have performed and, if appropriate, those that have to be undertaken within a certain deadline. The pilot of the aircraft consults the logbook so as to decide whether or not to perforin the mission assigned to the aircraft.

In practice, it is observed however that a discrepancy exists between the set of actions advised according to the lessons of the logbook and of the MEL and the set of actions that the maintenance personnel actually perform. This discrepancy may have several types of causes:
the procedures may be incomplete or imprecise,
the procedures may be irrelevant or partially irrelevant,
the maintenance personnel, based on their experience and/or intuition, perform certain non-advised actions or do not perform certain advised actions.

These various causes, listed in a non-exhaustive manner above, may obviously be compounded.

The consequences of this observation may be of various degrees of seriousness:
it may entail computers or equipment having been unjustifiably removed,
it may also entail errors having an impact on the future safety of the flight.

Consequently, today there appears to be a need for a better understanding and interpretation of the discrepancies observed between the advised maintenance actions and those actually carried out by maintenance personnel. The lesson drawn from this analysis indeed makes it possible to iteratively improve aircraft maintenance.

The problem that the present invention proposes to solve therefore resides in the current impossibility of measuring and taking into consideration the said discrepancies between the advised maintenance actions and the actions actually carried out in the design of aircraft maintenance procedures.

### SUMMARY OF THE INVENTION

For this purpose, the subject of the invention is a portable access terminal intended to aid the ground maintenance of an aircraft, comprising in internal memory a set of procedures in electronic form, a program operating on the said portable access terminal determining a set of advised actions requiring access to a set of advised procedures forming part of the said set of procedures, the said portable access terminal being utilized by an operator, the said operator carrying out a set of actions actually undertaken, which is assumed to be in compliance with the set of advised actions, and accessing a set of procedures actually consulted, which is assumed to be in compliance with the said set of advised procedures, said portable access terminal comprising:
first means for automatically recording the set of actions actually undertaken by the operator,
means for comparing the said set of actions actually undertaken with respect to the said set of advised actions, making it possible to measure a discrepancy between the set of actions actually undertaken and the set of advised actions,
second means for automatically recording the set of procedures actually consulted by the operator,
means for comparing the said set of procedures actually consulted with respect to the said set of advised procedures, making it possible to measure a discrepancy between the set of procedures actually consulted and the said set of advised procedures.

Advantageously, the portable access terminal according to the invention comprises means for automatically generating a report listing the set of actions actually undertaken.

Preferably, it furthermore comprises means for automatically generating an overview of the measured discrepancy between the set of actions actually undertaken and the set of advised actions.

Advantageously, it comprises means for automatically generating an overview of the measured discrepancy between the set of procedures actually consulted and the said set of advised procedures.

Advantageously, a system for aiding maintenance can comprise N portable access terminals; in a preferred mode of implementation, it moreover comprises means for compiling and comparing the measured discrepancies between the sets of actions actually undertaken and the sets of actions advised on the set of N portable access terminals.

Advantageously, the system for aiding maintenance according to the invention comprises means for analysing the measured discrepancies between the sets of actions actually undertaken and the sets of actions advised on the set of N portable access terminals allowing if appropriate a partial redefinition of the said sets of advised actions or a modification of the set of procedures.

Advantageously, for a given set of advised actions, the redefinition of the said set of advised actions is necessarily carried out as soon as at least M portable access terminals, M being less than or equal to N and greater than or equal to a first minimum number of occurrences, respectively exhibit a discrepancy between the said set of actions actually undertaken and the said set of advised actions comprising a common part.

Preferably, the set of procedures is necessarily modified as soon as at least P portable access terminals, P being less than or equal to N and greater than or equal to a second minimum number of occurrences, respectively exhibit a discrepancy between the set of advised procedures and the set of procedures actually consulted comprising a common part.

### BRIEF DESCRIPTION OF THE DRAWINGS

Other characteristics and advantages of the invention will become apparent with the aid of the description which follows given with regard to the appended drawings which represent:

FIG. 1: the diagram of an exemplary modelling of a portable access terminal intended to aid maintenance;

FIG. 2: the block diagram of an exemplary implementation of the scheme for iteratively improving the design of the aircraft maintenance process in the system according to the invention.

### DETAILED DESCRIPTION OF THE INVENTION

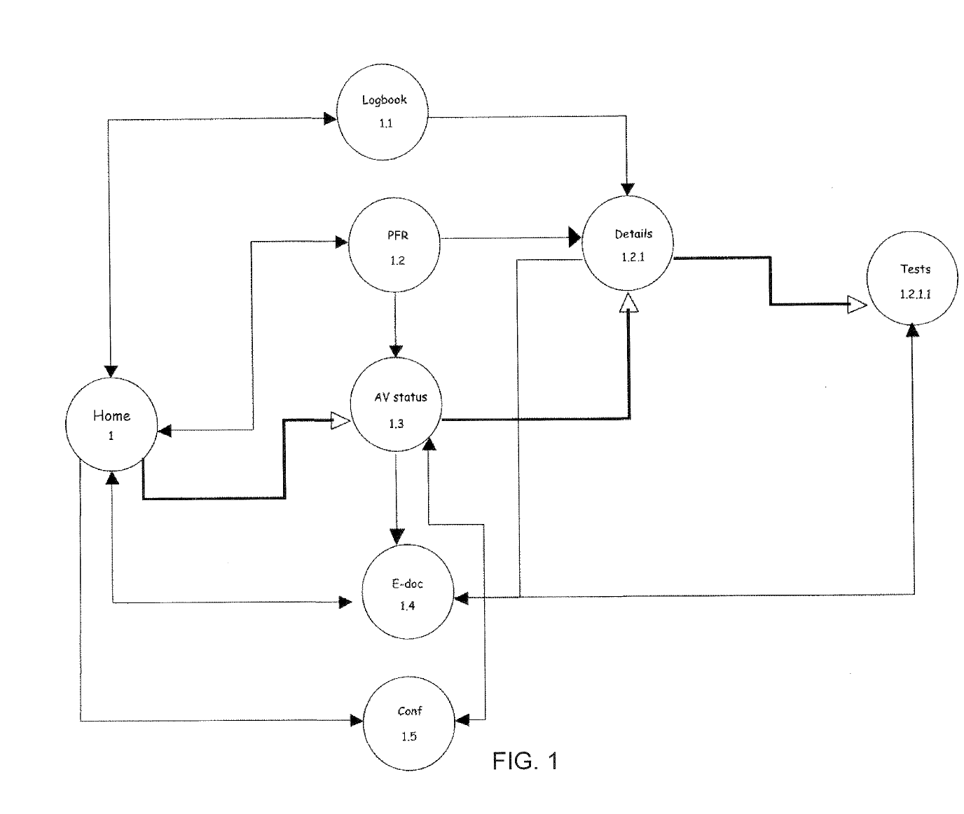

FIG. 1 presents a simple example of modelling a portable access terminal intended to aid maintenance, designated by the term PMAT. As was explained above in the overview of the invention, the PMAT according to the invention must comprise means making it possible to measure a discrepancy between the set of actions advised within the framework of the ground maintenance of an aircraft and the set of actions actually carried out by the maintenance personnel intervening on the said aircraft.

The means described above, constituting instrumentation of the PMAT, can be introduced through an object diagram modelling the PMAT. As shown by FIG. 1, indeed, it is possible to design the PMAT according to the invention on the basis of its modelling as an object diagram.

From “Home” 1, the PMAT makes it possible to access various first-level information sources, leading the maintenance personnel to possibly perform maintenance operations. These first-level information sources comprise the “Logbook” 1.1, corresponding to a flight register, the “PFR” 1.2, constituting a written record of the flight, the “Avionics status” 1.3, that is to say the general state of the aircraft, the “E-doc” 1.4, comprising the whole set of electronic documentation, and the “AV conf” 1.5, corresponding to the configuration of the aircraft.

The information arising for example from the “Logbook” 1.1, the “PFR” 1.2 and the electronic documentation “E-doc” 1.4 can be combined and lead to the detailed definition of faults, corresponding to the “Details” object 1.2.1. As a function of the faults to be processed and by referring to the electronic documentation, the PMAT can advise certain actions to the maintenance personnel, such as the running of specific tests, corresponding to the “Tests” object 1.2.1.1.

Within the framework of the implementation of this object model within a PMAT according to the invention, the “Details” 1.2.1 and “Tests” 1.2.1.1 objects comprise attributes corresponding to the previous and next objects selected. They furthermore comprise methods making it possible to record actions performed on the basis of these objects, such as clicking on a link to electronic documentation, the running of specific tests, the displaying of the state of the aircraft or of the configuration of the aircraft in relation to these objects. Through this exemplary modelling of a PMAT in the form of an object model, it is apparent that the invention proposes to implement tools allowing the instrumentation of a PMAT.

This instrumentation of the PMAT allows the automatic recording of the discrepancy, if any, existing on the one hand between the set of actions advised in respect of the maintenance of an aircraft and the actions actually carried out by the maintenance personnel, and on the other hand between the set of electronic documents that the maintenance personnel is presumed to have consulted and the set of electronic documents which they have actually accessed.

The PMAT according to the invention may preferably moreover comprise means aimed at the automatic preparation of a report providing an overview of this discrepancy, if any. With the aid of this report, it becomes easier to understand the behaviour of the maintenance personnel with a view to improving the aircraft maintenance strategies and procedures.

Indeed, the invention also consists of a system comprising N PMATs such as previously described and instrumented. The compilation and the analysis, by this system, of the N reports, if any, overviewing the discrepancies between the advised actions and the actions carried out, or between the prescribed procedures and those actually consulted, allows the consideration, which is paramount, of human factors in the design of the aircraft maintenance strategies and procedures. Consequently, the risk of human errors is reduced.

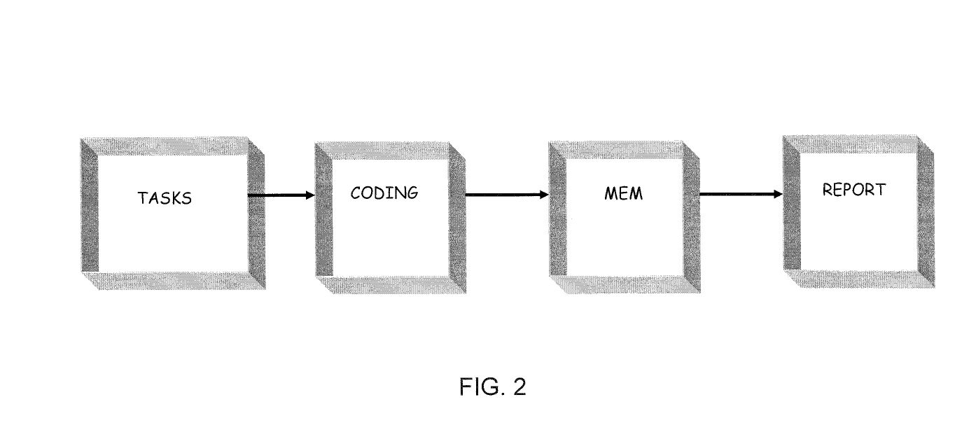

FIG. 2 illustrates by way of a block diagram the route allowing the preparation of the report on the discrepancy, if any, existing between the set of actions advised in respect of the maintenance of an aircraft and the actions actually carried out by the maintenance personnel.

The implementation of the invention comprises the recording of the actions undertaken by the maintenance personnel, corresponding to the step TASKS, their coding CODING with a view to their storage MEM. Finally, comparison with the set of advised actions and overview of a discrepancy, if any, is carried out by the REPORT function.

To summarize, the invention exhibits the advantage of allowing the consideration of human factors in the design of maintenance strategies and procedures in the field of aeronautics. The implementation of PMAT portable access terminals in the heart of a system for aiding maintenance eventually makes it possible to limit the risk of human errors within the framework of aircraft maintenance operations and, optionally, to adapt the maintenance strategies and procedures to particular profiles of maintenance personnel, as a function for example of the practices prevalent within airlines.

1. Portable access terminal intended to aid the ground maintenance of an aircraft, comprising in internal memory a set of procedures in electronic form, a program operating on the said portable access terminal determining a set of advised actions requiring access to a set of advised procedures forming part of the said set of procedures, the said portable access terminal being utilized by an operator, the said operator carrying out a set of actions actually undertaken, which is assumed to be in compliance with the set of advised actions, and accessing a set of procedures actually consulted, which is assumed to be in compliance with the said set of advised procedures, said portable access terminal comprising:
first means for automatically recording the set of actions actually undertaken by the operator,
means for comparing the said set of actions actually undertaken with respect to the said set of advised actions, making it possible to measure a discrepancy between the set of actions actually undertaken and the set of advised actions,
second means for automatically recording the set of procedures actually consulted by the operator,
means for comparing the said set of procedures actually consulted with respect to the said set of advised procedures, making it possible to measure a discrepancy between the set of procedures actually consulted and the said set of advised procedures.

2. Portable access terminal according to claim 1, comprising means for automatically generating a report listing the set of actions actually undertaken.

3. Portable access terminal according to claim 1, wherein said portable access terminal automatically generates an overview of the measured discrepancy between the set of actions actually undertaken and the set of advised actions.

4. Portable access terminal according to claim 2, wherein said portable access terminal automatically generates an overview of the measured discrepancy between the set of action actually undertaken and the set of advised action.

5. System for aiding maintenance, comprising N portable access terminal according to claim 1.

6. System according to claim 5, comprising means for compiling and comparing the measured discrepancies between the sets of actions actually undertaken and the sets of actions advised on the set of N portable access terminals.

7. System according to claim 6, comprising means for analyzing the measured discrepancies between the sets of actions actually undertaken and the sets of actions advised on the set of N portable access terminals allowing if appropriate a partial redefinition of the said sets of advised actions or a modification of the set of procedures.

8. System according to claim 7, wherein, for a given set of advised actions, the redefinition of the said set of advised actions is necessarily carried out as soon as at least M portable access terminals, M being less than or equal to N and greater than or equal to a first minimum number of occurrences, respectively exhibit a discrepancy between the said set of actions actually undertaken and the said set of advised actions comprising a common part.

9. System according to claim 7 wherein said set of procedures is necessarily modified as soon as at least P portable access terminals, P being less than or equal to N and greater than or equal to a second minimum number of occurrences, respectively exhibit a discrepancy between the set of advised procedures and the set of procedures actually consulted comprising a common part.

10. System according to claim 8 wherein said set of procedures is necessarily modified as soon as at least P portable access terminals, P being less than or equal to N and greater than or equal to a second minimum number of occurrences, respectively exhibit a discrepancy between the set of advised procedures and the set of procedures actually consulted comprising a common part.

11. Portable access terminal according to claim 1, comprising means for automatically generating an overview of the measured discrepancy between the set of procedures actually consulted and the said set of advised procedures.

12. Portable access terminal according to claim 4, comprising means for automatically generating an overview of the measured discrepancy between the set of procedures actually consulted and the said set of advised procedures.

13. System for aiding maintenance, comprising N portable access terminals according to claim 12.

14. System for aiding maintenance, comprising N portable access terminals according to claim 2.
